(19) United States
(12) Patent Application Publication
(10) Pub. No.: US 2015/0186999 A1
(43) Pub. Date: Jul. 2, 2015

(54) SYSTEMS AND METHODS FOR APPLICATION DISCOVERY, SUBSIDY AND ASSESSMENT

(71) Applicant: Aetna Inc., Hartford, CT (US)

(72) Inventors: Henry George Wei, New York, NY (US); Zhong Zhuang, New York, NY (US)

(73) Assignee: AETNA INC., Hartford, CT (US)

(21) Appl. No.: 14/143,188

(22) Filed: Dec. 30, 2013

(51) Int. Cl. G06Q 40/04; G06Q 30/06; G06Q 30/02; G06Q 50/22

(52) U.S. Cl. CPC G06Q 40/04; G06Q 30/0226; G06Q 50/22; G06Q 30/0621

(57) ABSTRACT

Embodiments of the disclosure provide systems and methods for application discovery, subsidy and assessment. The application can be a software application for use on a phone, tablet computer or other mobile device or a computer such as a laptop computer or desktop computer. In some embodiments, the application relates to health and/or well being of a patient or user of the application. Embodiments of the disclosure describe systems and methods for a user to discover applications in an online application store.

### BACKGROUND OF THE INVENTION

Software applications are distributed in various ways. Historically, consumer applications were distributed on various physical devices including floppy disk, CD-ROM or DVD for installation on a consumer's computer. Applications are now available for a variety of devices including laptop and desktop computers, tablet computers and smart phones. Applications are still distributed on physical devices, but are also now distributed through application stores that electronically transmit applications to user devices over a computer network, such as the interne.

Some applications have been made available for free by their developers. Other applications cost a one-time or recurring fee to use. For example, free applications can be downloaded from an application store by simply visiting the store. To download a fee based application, a user must enter payment information, such as credit card information and purchase the application before it can be downloaded.

Consumers have a difficult time discovering useful applications and evaluating applications. Consumers may read reviews of applications or view ratings in an application store. However, with millions of applications available across various devices and computing platforms, discovering new, useful applications is difficult.

Additionally, some applications are designed to help users with specific issues. For example, weight loss applications may help a user lose weight. However, the effectiveness of the application is not tracked nor easily discoverable by users. Application developers and others such as doctors and even the users themselves are not able to identify whether a particular application was effective.

### BRIEF SUMMARY OF THE INVENTION

This disclosure describes systems and methods for application discovery, subsidy and assessment. In one embodiment, a method of providing subsidized volume application purchases is described. The method includes storing, in a transaction processing system, payment information for a health plan sponsor to subsidize applications for a plurality of health plan members. Stored health plan member information for each of the plurality of health plan members is associated with the health plan sponsor. The transaction processing system stores an indication of an application to be made available to the health plan members associated with the health plan sponsor. The transaction processing system stores a quantity of the application purchased for the health plan members. The transaction processing system stores the duration of application subscriptions purchased for health plan members. At least one health plan member is provided access to the application.

Other embodiments provide a method of collecting payment information for a sponsor to purchase subsidized applications on behalf of eligible users. A transaction processing system stores payment information for the sponsor to subsidize applications. Eligibility information is stored for the sponsor's associated members. The transaction processing system receives parameters from the sponsor for purchases of applications.

Other embodiments describe a method of providing subsidized volume application purchases. A transaction processing system stores payment information for a health plan sponsor to subsidize applications for a plurality of health plan members. Stored health plan member information for each of the plurality of health plan members is associated with the health plan sponsor. The transaction processing system receives an indication of a plurality of applications to be made available to the health plan members associated with the health plan sponsor, and/or where appropriate, the duration of application access for subscription-based applications. The transaction processing system receives a quantity and/or duration for each of the plurality of applications purchased for the health plan members. At least one health plan member is provided a listing of available applications to the at least one health plan member.

Other embodiments provide application recommendations to individuals. The method includes storing, in a discovery processing system, health profile information for a health plan member. The discovery processing system stores application attributes for a plurality of healthcare applications. The discovery processing system stores at least one healthcare application with a health plan member based on the health profile information and healthcare application attributes. The discovery processing system transmits the matched healthcare application to the health plan member.

Additional embodiments provide a method for assessing the efficacy of an application. An efficacy processing system stores a relationship between a user, a health outcome and an application. The efficacy processing system stores relationships between users and health profile data found in health insurance, electronic health record and personal health record data. The efficacy processing system stores survey data to prompt users for self-reported health data and outcomes. The efficacy processing system transmits the survey data to an application. The efficacy processing system receives responses to the survey data. The efficacy processing system groups and/or matches users for cohort analyses. Comparative effectiveness and comparative safety of applications versus a comparison groups is determined. The efficacy processing system processes survey response data on application usage and user health profile and user health outcomes data. The health economic impact data for applications is determined.

### BRIEF DESCRIPTION OF THE SEVERAL VIEWS OF THE DRAWING(S)

FIG. 1 is a diagram of a system for processing application sponsorships according to embodiment.

FIG. 2 illustrates a user interface for viewing sponsored applications according to one embodiment.

FIG. 3 is a diagram of a system for recommending applications to users according to one embodiment.

FIG. 4 is a diagram of a system for determining the efficacy of an application according to one embodiment.

FIG. 5 is a flow chart of a method of providing volume application purchases according to one embodiment.

FIG. 6 is a flow chart of a method for providing application recommendations to individuals according to one embodiment.

FIG. 7 is a flow chart of a method for assessing the efficacy of an application according to one embodiment.

FIG. 8 is a schematic diagram showing hardware components of a transaction processing system according to one embodiment.

### DETAILED DESCRIPTION OF THE INVENTION

Embodiments of the disclosure provide systems and methods for application discovery, subsidy and assessment. The application can be a software application for use on a phone, tablet computer or other mobile device or a computer such as a laptop computer or desktop computer. In some embodiments, the application relates to health and/or well being of a patient or user of the application. Embodiments of the disclosure describe systems and methods for a user to discover applications in an online application store. The applications can be free, paid for by the user, paid for by a subsidy provider or partially paid for by a user and partially paid for by a subsidy provider. Additional embodiments describe a system for evaluating the efficacy of applications, including applications relating to health and/or well being of a patient or user of the application.

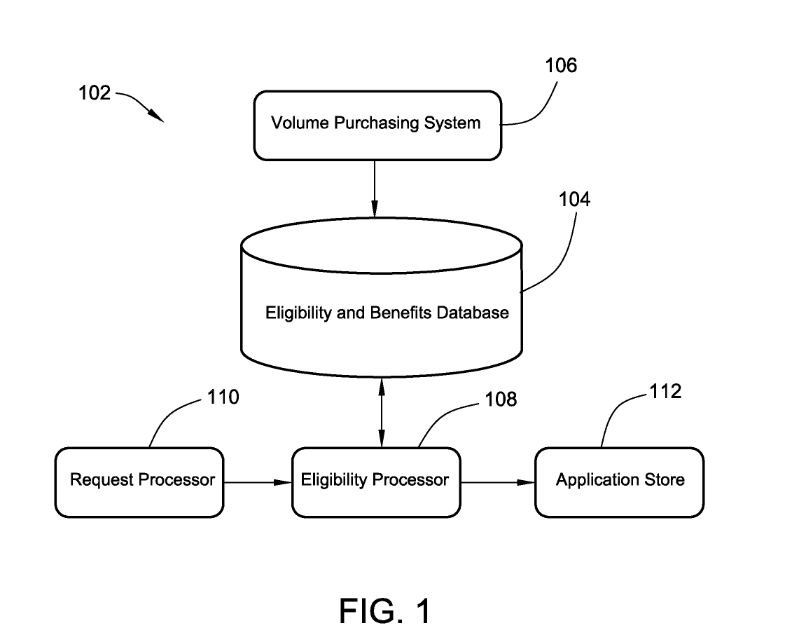

Turning to FIG. 1, a diagram of a system for processing application sponsorships is illustrated. A transaction processing system 102 is illustrated. The transaction processing system 102 includes an eligibility and benefits database 104. The eligibility and benefits database 104 stores sponsor and user or member level identification data. The sponsor subsidizes applications while the user is the end user of an application. In one embodiment, the sponsor is a healthcare plan sponsor, such as an employer that provides a healthcare plan for its employees. In other embodiments, the sponsor is a company or other entity that subsidizes applications for marketing, publicity, goodwill or other reasons.

The eligibility and benefits database 104 also stores sponsor and user application requests, application fulfillment parameters, denials and status. In some embodiments the sponsor and user application requests, application fulfillment parameters, denials and status information is stored in a separate database. A parameter can be stored in the database to indicate whether a particular member is eligible to receive a particular application. In this way subsets of members can be given access to particular applications. In some embodiments, a ranked list of members is created. Members gain access to the application based on their placement on the list. For example, if 100 copies of an application were subsidized, the first 100 members on the ranked list would be given access to the application. In this way an application can then be made available to members through a tiered campaign. For example, a first block of members on the ranked list may be provided access to a subsidized application for a set amount of time. If all applications have not been claimed, a second block of members on the ranked list may be provided access to the subsidized application. In some embodiments, an application will be sponsored for a limited time. The eligibility and benefits database 104 stores time period during which the application will be available to health plan members. In alternative embodiments, an application is partially subsidized by the sponsor and the member must pay for a portion of the application.

The eligibility and benefits database 104 interfaces with a volume purchasing system 106. The volume purchasing system 106 enables sponsors to transact procurement of bulk advance purchases and/or commitments to purchase applications. In one embodiment, a sponsor bulk purchases a set number of copies of an application in advance. The volume purchasing system 106 may store various pieces of data, including payment information for the sponsor. As described below, the subsidized application will be made available to users until the purchased number of copies have been downloaded. Inventory data can be calculated and stored based on the number of copies purchased and the number of applications redeemed. The sponsor may be provided redemption data over time and notified that more copies of the application need to be purchased as the number of available copies diminishes to a certain threshold. The sponsor may receive a lower price if a certain threshold number of copies of an application has been purchased. In other embodiments, a sponsor may commit to bulk purchasing of an application. The volume purchasing system 106 may store various pieces of data including payment information for the sponsor. The subsidized application will be made available to users and the number of redeemed applications will be stored. The application vendor may be provided redemption data over time so as to invoice or otherwise request payment for the redeemed applications. In some embodiments, the application seller may provide a sliding scale of incrementally lower payment per application to the sponsor. In other embodiments, the sponsor may purchase an application usage license, allowing a specified number of users to download the application. In alternative embodiments, multiple sponsors may subsidize an application. For example, a first sponsor may sponsor 50% of the application and a second sponsor may subsidize 50% of the application. The application may then be free to a user.

The eligibility and benefits database 104 also interfaces with an eligibility processor 108. The eligibility processor 108 assesses application install requests from users. In one embodiment a healthcare plan sponsor only subsidizes applications for users that are members of a particular healthcare plan. In this embodiment, the eligibility processor 108 interfaces with the eligibility and benefits database 104 to determine if a user requesting a sponsored application is a member of a healthcare plan allowed by the sponsor. Additionally, the eligibility processor 108 interfaces with a request processor 110. In one embodiment, the request processor allows users, healthcare providers, such as doctors, and health plan sponsors to generate requests to make eligible, to invite or to install an application. Additionally, inquiries regarding sponsor subsidy eligibility and availability can be made. Inquiries regarding sponsor subsidy eligibility and availability may be tracked. Sponsors can be notified of highly requested applications so that they have the opportunity to begin sponsoring them.

The eligibility processor 108 also interfaces with the application store 112. In one embodiment, the application store provides users with the ability to download subsidized applications. The eligibility processor 108 provides the application store an indication of whether a user has been approved to download a subsidized application. In some embodiments, a user requests a subsidized application through the application store 112. The application store 112 interfaces with the eligibility processor 108 and the eligibility processor 108 returns a parameter indicating whether the user can obtain the subsidized application. In some embodiments, the user is given the option to purchase an application if the user is not eligible to download the subsidized application. In some embodiments, all users are eligible to download a subsidized application. In some embodiments, users are sent credits redeemable or a redemption code for the application. The member can then use the credit to download the application. In some embodiments, the eligibility processor transmits uniquely-identified users pre-authorized for subsidized applications to the application store, whereby the pricing and subsidy is later rendered locally within the application store system upon request by the user.

In some embodiments, the eligibility processor 108 and eligibility database 104 tracks and stores data relating to application purchase and/or download by users. The data can then be provided to sponsors. For example, the eligibility processor 108 and eligibility database 104 may track users with a redemption code or redeemable credits and provide the sponsor with credit usage data. In other embodiments, the eligibility processor 108 and eligibility database 104 receives and imports user-level redemption and usage data from the application store provider. In other embodiments, the eligibility processor 108 and eligibility database 104 may store and display demographic information for users of the applications or cohorts of users, as explained below. The eligibility processor 108 and eligibility database 104 may store and provide to sponsors, application providers, application stores or other authorized parties a list of subsidized applications for a given user.

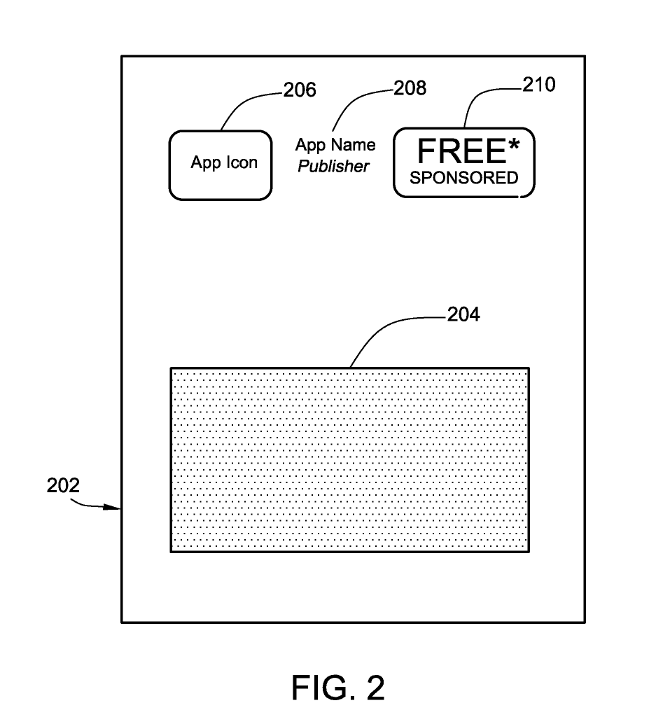

FIG. 2 illustrates a user interface for viewing sponsored applications according to one embodiment. The store interface 202 allows a user to view information about an application. A description of the application is provided in box 204. The application's icon is shown in box 206 and the application name and publisher is displayed 208. An icon 210 displays whether an application is subsidized, free or costs money. In the illustrated embodiment, the icon 210 shows that the application is free to download through subsidy with a sponsor. In alternative embodiments, additional data may be displayed, such as the original cost of the application.

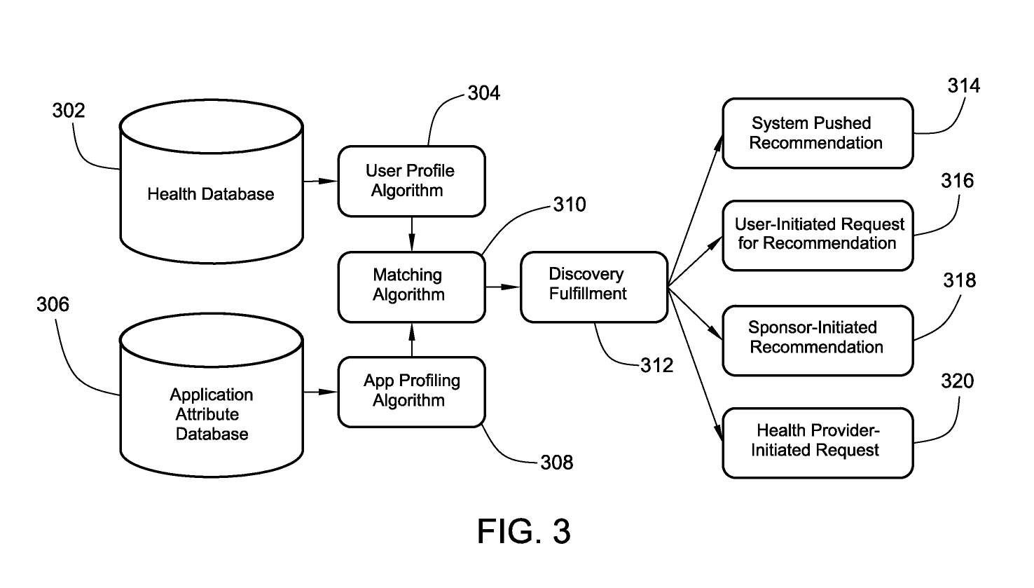

FIG. 3 is a diagram of a system for recommending applications to users according to one embodiment. Health database 302 stores health profile information including health, wellness and medical data and associates the data with user preference profile data. Health database 302 may store patient or provider entered health data as well as health claims data. The claims data may include medical diagnoses, procedures, tests, pharmacy data and/or lab results. The health profile information may be generated from electronic medical records, health insurance data and/or pharmacy benefits data. A user profiling algorithm 304 analyzes the data in the health database 302 to generate a profile for a user. The profile may be generated on an automatic or manually initiated basis. Users are profiled according to their health, wellness and user preference data. Specific conditions are identified for users and user populations. For example, women with diabetes or overweight men are identified.

Application attribute database 306 stores information relating to various applications according to the application's focus. Application profiling algorithm 308 develops a profile for applications based on the data stored in the application attribute database 306. For example, the application profiling algorithm 308 may determine an application is focused on women with diabetes or overweight men. Matching algorithm 310 assesses a fit between users and applications based on the user profiling algorithm 304 and the application profiling algorithm 308. For example, the matching algorithm 310 may match women with diabetes or overweight men with applications focused on women with diabetes or overweight men respectively. In one embodiment, statistical matching is performed for cohort analyses to determine comparative effectiveness and comparative safety of applications versus a control and applications versus each other. Propensity score matching via linear regression and/or logistic regression may be used for the statistical matching for comparative analyses. In some embodiments, a user is prompted to provide information relating to their favorite applications, owned applications and most used applications. This prompt may be in the form of a survey. A profile can be generated from the responses for use by the user profiling algorithm 304 and matching algorithm 310. The matching algorithm 310 can also use data such as user application requests and user navigation history in making a match. For example, a user that has requested weight loss applications and navigated to weight loss applications may be matched with weight loss applications in the future.

After the matching algorithm 310 assesses a fit between users and applications, the discovery fulfillment component 312 notifies users of a match. The fulfillment component may push a recommendation 314 by, for example, sending a notification, text message, email message, through a web application, mobile push message, telephone call or traditional mailing. The notification may include various messages including the name of the application, a summary of the application and/or information relating to the sponsor of the application. A user may initiate a request 316 for a recommendation by, for example, using an application, sending an email, sending a text message or making a telephone call. A sponsor, such as a health plan sponsor, may initiate a recommendation 318 for members. Additionally, a health provider may initiate a recommendation 320 for users. Recommendations can be filtered by member device and/or computing platform or operating system. In some embodiments, a ranked list of matched applications can be provided to a user. For example, the application with the best match may be listed first; the application with the second best match will be listed second and so on. Additionally, as a user is an application store 112, similar applications may be displayed to the user. In this way, a user immediately receives suggestions for applications.

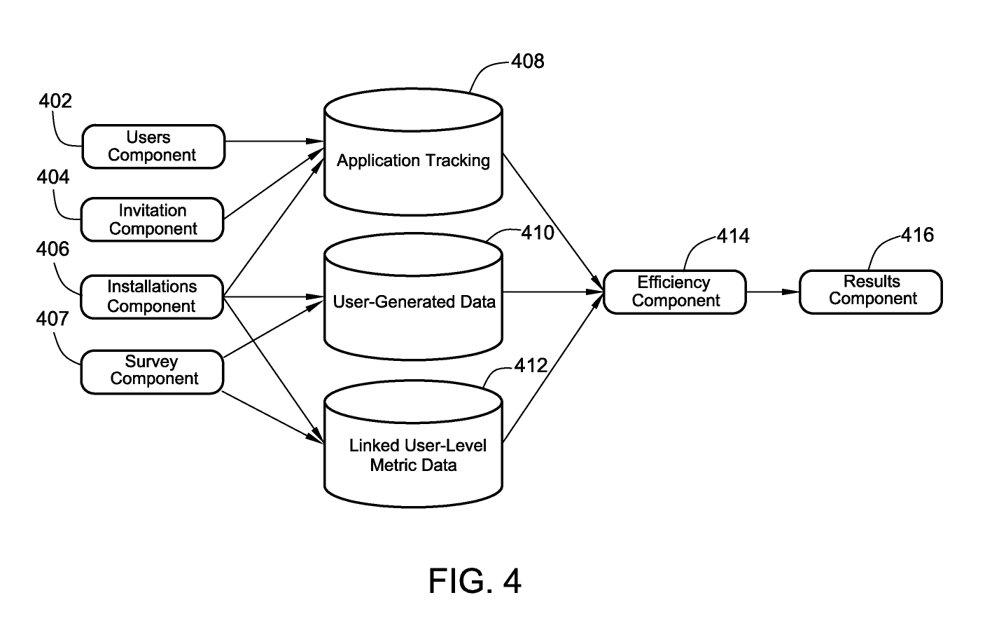

FIG. 4 is a diagram of a system for determining the efficacy of an application. Users component 402 determines sets of users that are eligible to install an application. In one embodiment, the users component 402, uses the matching algorithm 310 to develop the sets of users or populations. The invitation component 404 then invites identified users to install the application and the installation component 406 monitors which users agree to install the application and in some embodiments, tracks usage of the applications and can receive survey data from users relating to the applications. The application tracking database 408 interfaces with the users component, invitation component 404 and installation component 406 to store user application eligibility, invitation, installation and usage data. The user generated data database 410 interfaces with the installation component 406 and the survey component 407 to store user generated data, such as survey based metrics. In some embodiments, the survey component 407 transmits surveys to users and receives responses. Surveys may relate to how often an application is used, and whether the user is achieving the intended outcome from using the application. For example, a survey relating to a weight loss application may prompt a user to enter data relating to how often the application is used and the user's weight. In some embodiments, certain data that is collected by the application is automatically transmitted to the linked user level metric database 412. For example, a weight loss application that tracks weight over time may automatically transmit that data to the linked user level metric database 412. In some embodiments, the user level metric database 412 stores application usage data for users or groups of users. The application usage data can then be made available to sponsors. In this embodiment, applications transmit usage data, such as application redemption and install status, amount of time spent using the application, date and/or time of use and aspects of the application that were used to the user level metric database 412.

The efficacy component 414 assesses and quantifies the effect of applications for a population based on statistical analysis. The analysis may include, for example, Gower measures and k-means clustering. In some embodiments, the system gathers data sets of independent and dependent variables based on users eligible, invited, installing and using applications. The efficacy component 414 then analyzes the data against linked effectiveness and safety data derived from externally-derived data (e.g. medical data as in insurance claims and/or electronic health records) and user-generated data (e.g. self-reported survey-based metrics). Results are then statistically analyzed for effects on outcomes of interest including safety and effectiveness. Aggregate data are then generated for multiple purposes including aggregate health outcomes reporting, app-level effectiveness ratings, and safety reports for regulatory filings. The aggregate data is compiled in the results component 416. The data may be provided on a de-identified basis to preserve user anonymity. The results component may be used for aggregate reports, application discovery by, for example, interfacing with the system described in FIG. 3 (e.g. effectiveness ratings) and further analysis (e.g. trending; bundling scenarios; safety & effectiveness studies). The data may be provided through an application programming interface (API). The aggregated data may include health impact data for safety reports for regulatory filings. Health impact data may include efficacy data relating to an application.

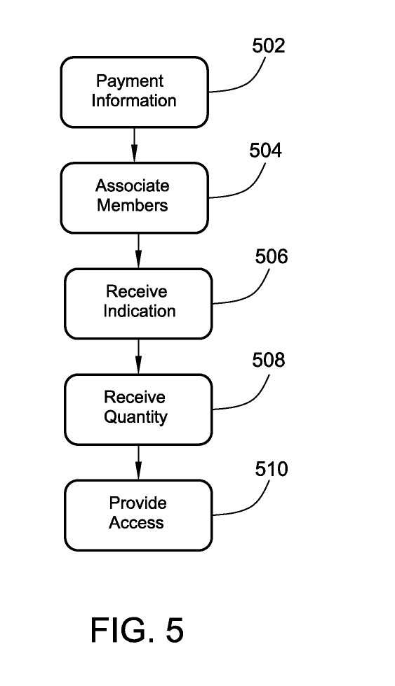

FIG. 5 is a flow chart of a method of providing volume application purchases according to one embodiment. At step 502, a transaction processing system, such as the system shown in FIG. 1, stores payment information for a health plan sponsor to subsidize applications for a plurality of health plan members. At step 504 stored health plan member information for each of the plurality of health plan members is associated with the health plan sponsor. In this way, a health plan sponsor can choose to subsidize applications only for its health plan members. In alternative embodiments, sponsors are not associated with the healthcare industry and can subsidize applications for any set of users or members. The transaction processing system receives an indication of an application to be made available to the health plan members associated with the health plan sponsor at step 506. The indication may be received directly from the sponsor. At step 508, the transaction processing system receives a quantity of the application purchased for the health plan members. In some embodiments, the application is purchased for all members. The quantity can be specified as a number of members eligible to receive the application, a number of devices eligible to run the application or a maximum amount the sponsor will spend on an application. Based on the volume of applications being purchased, the sponsor may receive a discount. At step 510, at least one health plan member access to the application. In some embodiments, the members are provided access using the systems and interfaces shown in FIG. 1 and FIG. 2. For example, a user may be notified through a text message, email message, through a web application, mobile push message, telephone call or traditional mailing. The sponsor can order additional copies or renew their order at any time. In other embodiments, the applications are first redeemed and distributed, and then the quantity and cost of the applications provided is presented to the sponsor for payment of the combined subsidy.

In some embodiments, credits redeemable or a redemption code for the application are generated and transmitted to the member. The member can then use the credit to download the application. In some embodiments, the system notifies members of the subsidized application as shown in FIG. 3. The notification may include a link to download the application and information relating to the sponsor, such as the sponsor's name. In alternative embodiments, the application is automatically transmitted to a health plan member's device. In this way, the health plan member immediately gains access to the application. In other embodiments, the transaction processing system receives an indication of a plurality of applications to be made available to the health plan members associated with the health plan sponsor. Members are provided with either a full listing or a subset of the applications. The members can then choose which applications to obtain.

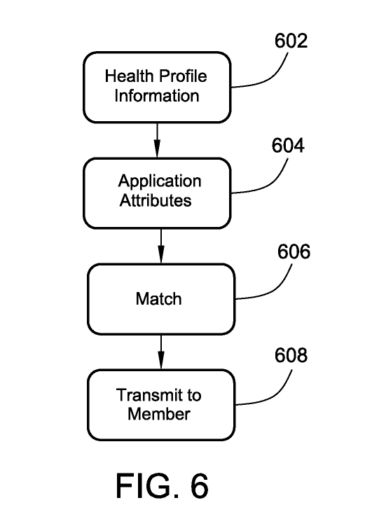

FIG. 6 is a flow chart of a method for providing application recommendations to individuals. In some embodiments, the system shown in FIG. 3 to implement the method. At step 602 a discovery processing system stores health profile information for a health plan member. The health profile information may be submitted by a patient or provider as well as health claims data submitted in connection with an insurance claim. The health profile data may include data on diagnoses, procedures, medications, tests and laboratory results, biometric data, health habits and risk factors. At step 604 the discovery processing system stores application attributes for a plurality of healthcare applications. As described above, the attributes may be stored in application attribute database 306.

At step 606, the discovery processing system matches at least one healthcare application with the health plan member based on the health profile information and healthcare application attributes. The matching system may use statistical clustering to identify profile types appropriate to specific healthcare applications based on an analysis of healthcare application usage data from a plurality of users who have used the healthcare application. Gower measures and k-means clustering may be used. Additionally, the matching algorithm may analyze outcomes data for the plurality of healthcare applications. The outcomes data may include application engagement for users of the application, process measures, and healthcare utilization rates attributable to use of the healthcare application. More effective applications are then more likely to be recommended. The outcomes data may be gathered using the system shown in FIG. 4.

At step 608, the discovery processing system transmits the matched healthcare application to the health plan member. In some embodiments, the sponsor is notified of the matched healthcare application.

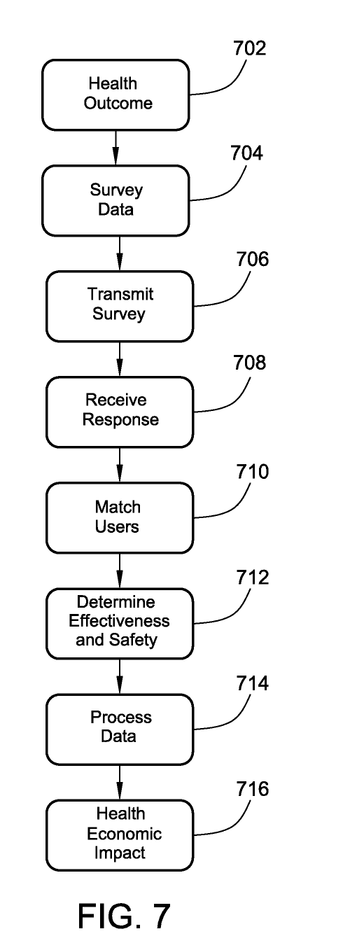

FIG. 7 is a flow chart of a method for assessing the efficacy of an application. In some embodiments, the system shown in FIG. 4 may be used. At step 702, an efficacy processing system stores a relationship between a user, a health outcome and an application. For example, information on a member using a weight loss program and whether they have lost weight is stored. At step 704, the efficacy processing system stores survey data to prompt users for self-reported outcomes related to use of an application. At step 706 the efficacy processing system transmits the survey data to the user. The system can transmit the survey through the application, email, text message, web application or other method. At step 708 the efficacy processing system receives the user's responses to the survey data. At step 710, the efficacy processing system matches users for cohort analyses. Users may be grouped based on any relevant factor, such as demographic data such as age and gender, and health profile data including medical procedures, tests, pharmacy data and lab results. At step 712, the comparative effectiveness and comparative safety of applications versus a control are determined. The control may consist of a user or group of users that have not used the application or have used a different application. At step 714, the efficacy processing system processes the survey response data on application usage and user health profile and user health outcomes data and at step 716 determines the health economic impact data for applications. The health economic impact may include the savings to the patient of using an application and/or the savings to a health plan sponsor of subsidizing an application, taking into account future healthcare savings. Health economic impact data may include inpatient services, emergency services, primary care and specialist physician services, laboratory services, radiology services, medication utilization, and health care costs.

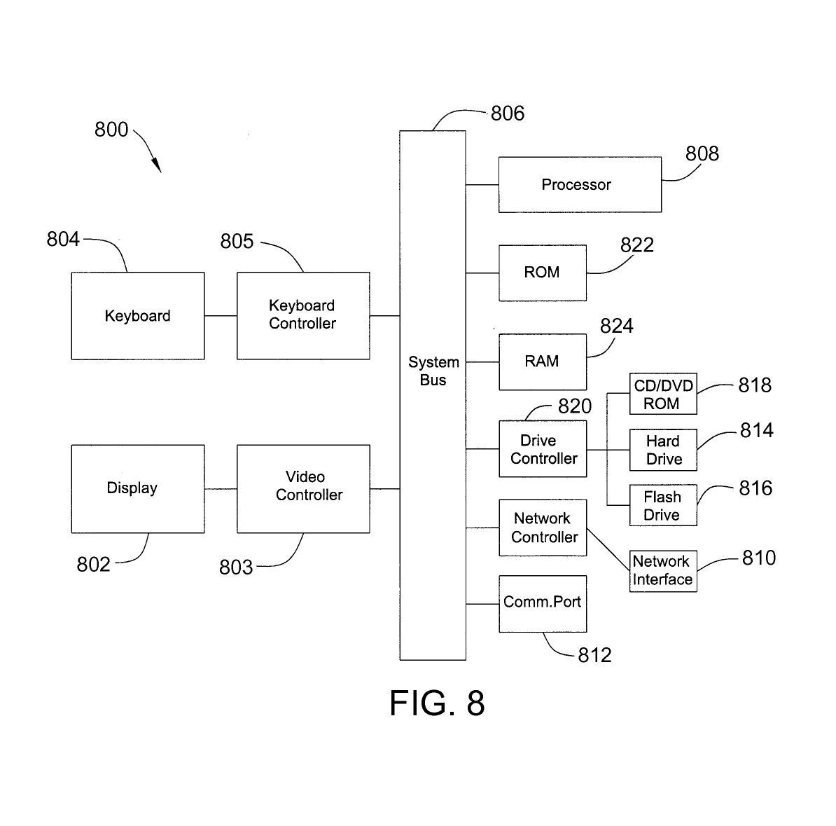

FIG. 8 is a schematic diagram showing hardware components of a transaction processing system according to one embodiment. Those skilled in the art will realize that the transaction processing system 102 may include one or more computing devices described herein. The computing device 800, such as a computer, including a dedicated special-purpose support management device, includes a plurality of hardware elements, including a display 802 and a video controller 803 for presenting to the user an interface for interacting with the system. The computing device 800 further includes a keyboard 804 and keyboard controller 805 for relaying the user input via the user interface. Alternatively or in addition, the computing device 800 includes a tactile input interface, such as a touch screen. The display 802 and keyboard 804 (and/or touch screen) peripherals connect to the system bus 806. A processor 808, such as a central processing unit (CPU) of the computing device or a dedicated special-purpose support management processor, executes computer executable instructions comprising embodiments of the support management system, as described above. In embodiments, the computer executable instructions are received over a network interface 810 (or communications port 812) or are locally stored and accessed from a non-transitory computer readable medium, such as a hard drive 814, flash (solid state) memory drive 816, or CD/DVD ROM drive 818. The computer readable media 814-818 are accessible via the drive controller 820. Read Only Memory (ROM) 822 includes computer executable instructions for initializing the processor 808, while the Random Access Memory (RAM) 824 is the main memory for loading and processing instructions executed by the processor 808. In some embodiments, the system for recommending applications shown in FIG. 3 and the system for determining the efficacy of an application shown in FIG. 4 use hardware components such as those illustrated in FIG. 8. Additionally, the user or member device may also use hardware components such as those illustrated in FIG. 8.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of providing volume application purchases comprising:
storing, in a transaction processing system, payment information for a health plan sponsor to subsidize applications for a plurality of health plan members;
associating stored health plan member information for each of the plurality of health plan members with the health plan sponsor;
receiving, in the transaction processing system, an indication of an application to be made available to the health plan members associated with the health plan sponsor;
receiving, in the transaction processing system, a quantity of the application and duration of application access purchased for the health plan members; and
providing at least one health plan member access to the application.

2. The method of claim 1 further comprising providing a discount to the health plan sponsor when its purchases exceed a threshold.

3. The method of claim 1 further comprising:
generating, by the transaction processing system, credits redeemable for the application; and
transmitting, by the transaction processing system, the credits to the health plan members.

4. The method of claim 1 further comprising notifying, by the transaction processing system, the health plan members that a subsidized application is available.

5. The method of claim 4 further comprising transmitting, by the transaction processing system, a link to the subsidized application to the health plan members.

6. The method of claim 5 further comprising transmitting the link to subsidized application as a tiered campaign.

7. The method of claim 4 wherein the notification includes sponsor identification information.

8. The method of claim 1 further comprising receiving a request for the health plan sponsor to subsidize an application from at least one health plan members.

9. The method of claim 1 further comprising transmitting, automatically, the application to at least one health plan member device.

10. The method of claim 1 wherein the quantity of the application purchased is received as a maximum number of users eligible to download the application.

11. The method of claim 1 wherein the quantity of the application purchased is received as a maximum amount to be spent on the application.

12. The method of claim 11 further comprising receiving, in the transaction processing system, a renewed quantity of the application purchased for the health plan members.

13. The method of claim 1 further comprising storing a parameter, at the transaction processing system, indicative of health plan member eligibility to receive the application including at least one of eligible, non-eligible, and pending eligibility statuses.

14. The method of claim 14 wherein the parameter comprises a ranked list of health plan members given access to the application.

15. The method of claim 1 further comprising storing, at the transaction processing system, a time period during which the application will be available to health plan members.

16. The method of claim 1 further comprising storing an inventory of the application available for health plan members.

17. The method of claim 1 further wherein the providing step further comprises transmitting a redemption code to the health plan member.

18. The method of claim 1 further wherein the providing step further comprises transmitting a set of identified pre-approved health plan members for an application to the application store provider.

19. The method of claim 1 wherein the health plan sponsor subsidizes the full cost of the application.

20. The method of claim 1 wherein the health plan sponsor subsidizes part of the cost of the application.

21. The method of claim 1 further comprising tracking, in the transaction processing system, application redemption data.

22. The method of 21 further comprising displaying a percentage of the application redemption data versus a total purchase volume for the application.

23. The method of 21 further comprising displaying application redemption over time.

24. The method of claim 21 further comprising notifying the health plan sponsor when the redemption data reaches a predetermined threshold.

25. The method of claim 24 further comprising allocating, in the transaction processing system, a second quantity of the application purchased when the redemption data reaches a predetermined threshold.

26. A method of collecting payment information for a sponsor to purchase subsidized applications, the method comprising:
storing payment information, in a transaction processing system, for the sponsor to subsidize applications;
storing eligibility information for the sponsor's associated members; and
receiving parameters, in the transaction processing system, from the sponsor for purchases of applications.

27. A method of providing volume application purchases comprising:
storing, in a transaction processing system, payment information for a health plan sponsor to subsidize applications for a plurality of health plan members;
associating stored health plan member information for each of the plurality of health plan members with the health plan sponsor;
receiving, in the transaction processing system, an indication of a plurality of applications to be made available to the health plan members associated with the health plan sponsor;
receiving, in the transaction processing system, a quantity for each of the plurality of applications purchased for the health plan members; and
providing at least one health plan member a listing of available applications to the at least one health plan member.

28. The method of claim 27 wherein the available applications to the at least one health plan member is a subset of the plurality of applications.

29. A method for providing application recommendations to individuals comprising:
storing, in a discovery processing system, health profile information for a health plan member;
storing, in the discovery processing system, application attributes for a plurality of healthcare applications;
matching, in the discovery processing system, at least one healthcare application with the health plan member based on the health profile information and healthcare application attributes; and
transmitting, by the discovery processing system, the matched healthcare application to the health plan member.

30. The method of claim 29 further comprising notifying a health plan sponsor of the matched healthcare application.

31. The method of claim 29 wherein the health profile information includes at least one of a demographics, diagnoses, procedures, medications, laboratory results, health habits, and health risk factors.

32. The method of claim 31 further comprising, generating the health profile information from at least one of demographics, electronic medical records, health insurance data and pharmacy benefits data.

33. The method of claim 29 wherein the matching step further comprises performing statistical clustering to identify profile types appropriate to specific healthcare applications based on an analysis of healthcare application usage data from a plurality of users who have used the healthcare application.

34. The method of claim 29 further comprising:
prompting a user to select at least one of a favorite application, owned application, or used application; and
generating a user application profile for future matches.

35. The method of claim 29 wherein the matching step further comprises analyzing outcomes data for the plurality of healthcare applications.

36. The method of claim 35 wherein the outcomes data includes at least one of application engagement for users of the application, process measures, and healthcare utilization rates attributable to use of the healthcare application.

37. The method of claim 29 wherein the matching step further comprises performing statistical analysis of applications downloaded, usage, and satisfaction rates based on statistical similarity as by calculation of statistical distance metrics and pre-specified thresholding.

38. The method of claim 29 wherein the matching step further comprises analyzing at least one of user application requests and user navigation history.

39. The method of claim 29 further comprising filtering application recommendations by platform preference.

40. The method of claim 29 further comprising automatically transmitting application recommendations to users by at least one of email, SMS text messaging, web application and mobile application push message.

41. The method of claim 29 further comprising displaying best matched applications in a ranked list.

42. The method of claim 29 further comprising displaying similarly viewed applications as the user is browsing a specific application.

43. A method for assessing the efficacy of an application comprising:
storing, in an efficacy processing system, a relationship between a user, a health outcome and an application;
storing, in the efficacy processing system, survey data for self-reported outcomes;
storing, in the efficacy processing system, relationship data for application users to other health profile data;
transmitting, by the efficacy processing system, the survey data to the user;
receiving, in the efficacy processing system, responses to the survey data;
matching, in the efficacy processing system, users for cohort analyses;
determining comparative effectiveness and, comparative safety of applications versus a control;
processing, in the efficacy processing system, survey response data on application usage and user health profile and user health outcomes data; and
determining health economic impact data for applications.

44. The method of claim 43 further comprising aggregating the health impact data at a plurality of grouping levels.

45. The method of claim 44 further comprising presenting the aggregate health impact on a de-identified aggregate basis.

46. The method of claim 44 wherein a grouping level is displayed for analysis.

47. The method of claim 44 further comprising providing de-identified aggregate data through an application programming interface.

48. The method of claim 44 wherein the plurality of grouping levels includes at least one of a plan-sponsor level, app-level and developer-level.

49. The method of claim 48 further comprising reporting the aggregated health impact data to develop a care management strategy for a user.

50. The method of claim 44 further comprising reporting the aggregated health impact data for the use of safety reports for regulatory filing.

51. The method of claim 43 wherein the matching step further comprises statistical matching of eligible users by propensity score matching via linear regression.

52. The method of claim 43 wherein the health economic impact data is based on at least one of impact on hospital admission, emergency room visits, medication utilization, and health care costs.
